(19) United States
(12) Patent Application Publication
(10) Pub. No.: US 2024/0381127 A1
(43) Pub. Date: Nov. 14, 2024

(54) METHOD AND DEVICE FOR PROVIDING ARTIFICIAL INTELLIGENCE/MACHINE LEARNING MEDIA SERVICE USING USER EQUIPMENT CAPABILITY NEGOTIATION IN WIRELESS COMMUNICATION SYSTEM

(71) Applicant: Samsung Electronics Co., Ltd., Gyeonggi-do (KR)

(72) Inventors: Eric YIP, Gyeonggi-do (KR); Prasenjit CHAKRABORTY, Bangalore (IN)

(21) Appl. No.: 18/662,035

(22) Filed: May 13, 2024

(30) Foreign Application Priority Data
May 12, 2023 (IN) 202311033480

(51) Int. Cl. H04W 24/02; H04W 8/22; H04W 48/16

(52) U.S. Cl. CPC H04W 24/02; H04W 8/22; H04W 48/16

(57) ABSTRACT

Disclosed is a method and device for efficiently providing an artificial intelligence/machine learning (AI/ML) media service by a user equipment (UE), the method including receiving, from a network server, configuration information including information on a trained configuration AI model for checking a capability of the UE associated with a AI split inferencing between the UE and the network server, performing inferencing for a capability discovery of the UE based on the configuration information, and transmitting, from the network server, a capability metrics of the UE based on the inferencing result.

### CROSS-REFERENCE TO RELATED APPLICATION(S)

This application is based on and claims priority under 35 U.S.C. § 119 (a) to Indian Provisional Patent Application No. 202311033480, which was filed in the Indian Patent Office on May 12, 2023, the entire content of which is incorporated herein by reference.

### BACKGROUND

### 1. Field

The disclosure relates generally to a wireless communication system, and more particularly, to 5th generation (5G) network systems for multimedia, architectures and procedures for artificial intelligence/machine learning (AI/ML) model transfer and delivery over 5G for AI enhanced multimedia services and split AI/ML inferencing.

### 2. Description of Related Art

5G mobile communication technologies define broad frequency bands such that high transmission rates and new services are possible, and can be implemented not only in sub 6 gigahertz (GHz) bands such as 3.5 GHz, but also in above 6 GHz bands referred to as millimeter wave (mmWave) bands including 28 GHz and 39 GHz. In addition, it has been considered to implement sixth generation (6G) mobile communication technologies referred to as beyond 5G systems in terahertz (THz) bands (for example, 95 GHz to 3 THz bands) to achieve transmission rates fifty times faster than 5G mobile communication technologies and ultra-low latencies one-tenth of 5G mobile communication technologies.

Since 5G mobile communication technology development commenced, to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, operating multiple subcarrier spacings for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amounts of data transmission and a polar code for highly reliable transmission of control information, layer 2 (L2) pre-processing, and network slicing for providing a dedicated network specialized to a specific service.

Discussions persist regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access channel (2-step RACH) procedures for NR. There also has been ongoing standardization in system architecture/service regarding a 5G service based architecture or service based interface for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing AI and ML, AI service support, metaverse service support, and drone communication.

Such development of 5G mobile communication systems will serve as a basis for developing not only new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of THz band signals, high-dimensional space multiplexing technology using orbital angular momentum (OAM) and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

AI defines the capability for a system to act based on the context in which a task has to be done, meaning the value or state of different input parameters, and the past experience of achieving the same task with different parameter values and the record of potential success with each parameter value.

ML is often described as a subset of AI, in which an application has the capacity to learn from the past experience. This learning feature usually starts with an initial training phase to ensure a minimum level of performance when ML is placed into service.

AI/ML has been introduced and generalized in media related applications, ranging from legacy applications such as image classification and speech/face recognition, to more recent applications such as video quality enhancement. As research into this field matures, more complex AI/ML-based applications requiring higher computational processing can be expected. Such processing concerns significant amounts of data not only for the inputs and outputs into the AI/ML models, but also for the increasing data size and complexity of the AI/ML models. Based on this increasing amount of AI/ML related data, together with a need for supporting processing intensive mobile applications (such as VR, AR/MR, and gaming) there is a need in the art for a method and apparatus for handling certain aspects of AI/ML processing by the server over 5G system, to meet the latency requirements of various applications.

### SUMMARY

Aspects of the disclosure are to address at least the above-mentioned problems and/or disadvantages and to provide at least the advantages described below.

Accordingly, an aspect of the disclosure is to provide a method and device for efficiently providing an AI/ML media service using split AI/ML inferencing in a wireless communication system.

An aspect of the disclosure is to provide a method and device for efficiently providing an AI/ML media service using UE capability negotiation in a wireless communication system.

An aspect of the disclosure is to provide an enabled network status, UE capability/resource/status and multimedia context driven AI/ML model selection and split AI model inference decision/configuration, delivery and management between network and UE for AI multimedia services.

In accordance with an aspect of the disclosure, a method performed by a user equipment (UE) for an AI/ML media service in a wireless communication system includes receiving, from a network server, configuration information including information on a trained configuration AI model for checking a capability of the UE associated with a AI split inferencing between the UE and the network server, performing inferencing for a capability discovery of the UE based on the configuration information, and transmitting, from the network server, a capability metrics of the UE based on the inferencing result.

In accordance with another aspect of the disclosure, a UE for an AI/ML media service in a wireless communication system includes a transceiver, and a processor configured to receive, through the transceiver from a network server, configuration information including information on a trained configuration AI model for checking a capability of the UE associated with a AI split inferencing between the UE and the network server, perform inferencing for a capability discovery of the UE based on the configuration information, and transmit, to the network server through the transceiver, a capability metrics of the UE based on the inferencing result.

In accordance with another aspect of the disclosure, a method performed by a network server for an AI/ML media service in a wireless communication system includes transmitting, to a user equipment (UE), configuration information including information on a trained configuration AI model for checking a capability of the UE associated with a AI split inferencing between the UE and the network server, receiving, from the UE, a capability metrics of the UE based on the configuration information, and performing a matrix comparison for a capability discovery of the UE based on the capability metric of the UE.

In accordance with another aspect of the disclosure, a network server for an AI/ML media service in a wireless communication system includes a transceiver, and a processor configured to transmit, to UE through the transceiver, configuration information including information on a trained configuration AI model for checking a capability of the UE associated with a AI split inferencing between the UE and the network server, receive, through the transceiver from the UE, a capability metrics of the UE based on the configuration information, and perform a matrix comparison for a capability discovery of the UE based on the capability metric of the UE.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an overall 5G media streaming (5GMS) architecture in a wireless communication system according to an embodiment;

FIG. 2 illustrates a 5GMS general architecture in a wireless communication system according to an embodiment;

FIG. 3 illustrates a high level procedure for media downlink streaming in a wireless communication system according to an embodiment;

FIG. 4 illustrates a baseline procedure describing an establishment of a unicast media downlink streaming session in a wireless communication system according to an embodiment;

FIG. 5 illustrates an AI/ML media service scenario according to an embodiment;

FIG. 6 illustrates an AI/ML media service scenario according to an embodiment;

FIG. 7 illustrates an AI/ML media service scenario according to an embodiment;

FIG. 8 illustrates AI for media architecture which identifies the various functional entities and interfaces for enabling AI model delivery for media services according to an embodiment;

FIGS. 9A and 9B illustrate a procedure for the delivery of an AI model with configurations between the network and UE in a wireless communication system according to an embodiment;

FIG. 10 illustrates a procedure corresponding to step 903 in FIG. 9A;

FIG. 11 illustrates a trained configuration AI model for the capability configuration procedure described in the embodiment of FIG. 10;

FIGS. 12A, 12B and 12C illustrate different scenarios of capability negotiation to which the disclosure is applicable;

FIG. 13 illustrates a detail of the procedures corresponding to the embodiment of FIG. 10;

FIG. 14 illustrates a UE configuration block diagram for the process of capability configuration, using the configuration information, according to an embodiment; and

FIG. 15 illustrates a configuration of a network entity in a wireless communication system according to an embodiment.

### DETAILED DESCRIPTION

The following description with reference to the accompanying drawings is provided to assist in a comprehensive understanding of embodiments of the disclosure. The description includes details to assist in that understanding but these are to be regarded as examples. Accordingly, those of ordinary skill in the art will recognize that various changes and modifications of the embodiments described herein can be made without departing from the scope and spirit of the disclosure. In addition, descriptions of well-known functions and constructions may be omitted for the sake of clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description is provided for illustration purposes only and not for the purpose of limiting the disclosure.

It is to be understood that the singular forms a, an, and the include plural referents unless the context clearly dictates otherwise. Thus, for example, reference to a component surface includes reference to one or more of such surfaces.

For the same reasons, some elements may be exaggerated or schematically shown. The size of each element does not necessarily reflect the real size of the element. The same reference numeral is used to refer to the same element throughout the drawings.

Advantages and features of the disclosure, and methods for achieving the same may be understood through the embodiments to be described below taken in conjunction with the accompanying drawings. However, the disclosure is not limited to the embodiments disclosed herein, and various changes may be made thereto. The embodiments disclosed herein are provided only to inform one of ordinary skilled in the art of the category of the disclosure. The same reference numeral denotes the same element throughout the specification. As used herein, the term . . . unit indicates a software element or a hardware element. The . . . unit plays a certain role. However, the term unit is not limited to a software or hardware element and may be configured in a storage medium that may be addressed or may be configured to reproduce one or more processors. Accordingly, as an example, a unit includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. A function provided in an element or a unit may be combined with additional elements or may be divided into sub elements or sub-units. An element or a unit may be implemented to reproduce one or more central processing units (CPUs) in a device or a security multimedia card. A . . . unit may include one or more processors.

As used herein, each of such phrases as A and/or B, A or B, at least one of A and B, at least one of A or B, A, B, or C, at least one of A, B, and C, and at least one of A, B, or C, may include all possible combinations of the items enumerated together in a corresponding one of the phrases. As used herein, such terms as 1st and 2nd, or first and second may be used to distinguish a corresponding component from another and do not limit the components in importance or order.

In the disclosure, a UE may refer to a terminal, mobile station (MS), cellular phone, smartphone, computer, or various electronic devices capable of performing communication functions. A base station (BS) may be an entity allocating a resource to the UE and may be at least one of a gNode B, gNB, eNode B, eNB, Node B, BS, radio access network (RAN), base station controller, or node on network.

The disclosure may also apply to other communication systems with similar technical background or channel form and may be modified in such a range as not to significantly depart from the scope of the disclosure.

Herein, a communication system may use various wired or wireless communication systems, e.g., the new RAN (NR), which is the radio access network, and the packet core (5G system, or 5G core network, or next generation core (NG core)), which is the core network, according to the 5G communication standard of the 3GPP which is a radio communication standardization organization. Embodiments of the disclosure may also be applicable to communication systems with a similar technical background.

As used herein, terms for identifying access nodes and for denoting network entities (NEs), messages, interfaces between network functions (NFs), and various pieces of identification information are provided as an example for ease of description. Thus, the disclosure is not limited by the terms, and such terms may be replaced with other terms denoting objects with equivalent technical concept.

The 5G system may support the network slice, and traffic for different network slices may be processed by different protocol data unit (PDU) sessions. The PDU session may mean an association between a data network providing a PDU connection service and a UE. The network slice may be understood as technology for logically configuring a network with a set of network functions (NF) to support various services with different characteristics, such as broadband communication services, massive IoT, V2X, or other mission critical services, and separating different network slices. Therefore, even when a communication failure occurs in one network slice, communication in other network slices is not affected, so that it is possible to provide a stable communication service. In the disclosure, the term “slice” may be interchangeably used interchangeably with “network slice.” In such a network environment, the UE may access a plurality of network slices when receiving various services. Further, the network function (NF) may be a software instance running on hardware and be implemented as a virtualized function instantiated on a network element or an appropriate platform.

The mobile communication provider may constitute the network slice and may allocate network resources suitable for a specific service for each network slice or for each set of network slices. A network resource may mean an network function (NF) or logical resource provided by the NF or radio resource allocation of a base station.

For example, a mobile communication provider may configure network slice A for providing a mobile broadband service, network slice B for providing a vehicle communication service, and network slice C for providing a broadcast service. In other words, the 5G network may efficiently provide a corresponding service to a UE through a specialized network slice suited for the characteristics of each service. In the 5G system, the network slice may be represented as single-network slice selection assistance information (S-NSSAI). The S-NSSAI may include a slice/service type (SST) value and a slice differentiator (SD) value. The SST may indicate the characteristics of the service supported by the network slice (e.g., enhanced mobile broadband (eMBB), IoT, ultra-reliability low latency communication (URLLC), V2X, etc.). The SD may be a value used as an additional identifier for a specific service referred to as SST. In the disclosure, the network technology may refer to the relevant Standards (e.g., TS 23.501, TS 23.502, TS 23.503, etc.) defined by the international telecommunication union (ITU) or the 3rd generation partnership project (3GPP). Each of the components included in the network architecture herein indicates a physical entity or indicates software that performs an individual function or hardware combined with software. Reference characters denoted by Nx in the drawings, such as N1, N2, N3, . . . , etc., indicate known interfaces between NFs in the 5G core network (CN), and the relevant descriptions may be found in the relevant Standard(s). Therefore, a detailed description will be omitted.

Current implementations of AI/ML are mainly proprietary solutions, enabled via applications without compatibility with other market solutions. In order to support AI/ML for multimedia applications over 5G, AI/ML models should support compatibility between UE devices and application providers from different MNOs. Not only this, but AI/ML model delivery for AI/ML media services should support media context, UE status, and network status based selection and delivery of the AI/ML model. The processing power of UE devices is also a limitation for AI/ML media services, since next generation media services, such as AR, are typically consumed on lightweight, low processing power devices, such as AR glasses, for which long battery life is also a major design hurdle/limitation.

Due to such limitations, AI inferencing for such media applications will commonly leverage network resources such as the cloud or edge, for split inferencing between the network and UE device, where a part of the AI model is inferenced in the network, and the rest of the AI model is inference on the UE device (the reverse is also possible).

Nevertheless, for such scenarios where inferencing (whether full or split) needs to take place on the UE device, either the full or partial split AI model must be delivered to the UE from the network.

The decision of how to split an AI model for split inferencing between two different entities (one of which should include an UE) depends much on the nature of the service (i.e. the characteristics of the AI model), but also UE's capability and resource availability. As such, after the service announcement for the service, discovery of the UE's AI capability and resource availability is vital in the decisions and configurations for the split inference AI media service. A summary of the problem statements includes:
AI inferencing for media processing is computationally heavy, requiring leverage of network resources
AI model needs to be delivered from network to UE as user plane data
Split AI inferencing between UE and network requires negotiations and configurations to decide the split configuration(s) between the UE and network
Split configurations are dependent on the UE device capabilities, however, measuring of UE AI media capabilities has several problems:
   There are no profiles for AI/ML which are similar or equivalent to media capabilities (e.g. code profiles, or levels)
   Hardware capability discovery and reporting is both:
      Difficult: since different measurements as used by different manufacturers (e.g. GPUs, CPUs, Tensor Corse, TPUs, etc)
      Insufficient: since hardware capability alone does not reflect the current available AI resource or AI performance of the UE
   The capability and performance is also dependent on the AI task at hand for the service (include the model type, size, input data type, etc). Unlike media codec capabilities where specific codecs are pre-defined, AI models are typically not pre-defined for a given service.

Disclosed herein are mechanisms for UE AI capability and resource discovery, in particular for UE inferencing and UE-network (or UE-UE) split inferencing, where:
As part of the UE AI capability and resource discovery before the service session, a UE AI capability configuration and calibration for the service is introduced
During the capability configuration and calibration, a dummy trained AI/ML model is delivered to the UE, and is inferenced for capability discovery
Disclosed are embodiments related to the above mechanisms, namely:
   The data needed for the capability configuration and calibration
   How the necessary data is delivered to the UE
   Metrics resulting from the capability configuration inference, which are reported to the network from the UE, used for the decision of split negotiation

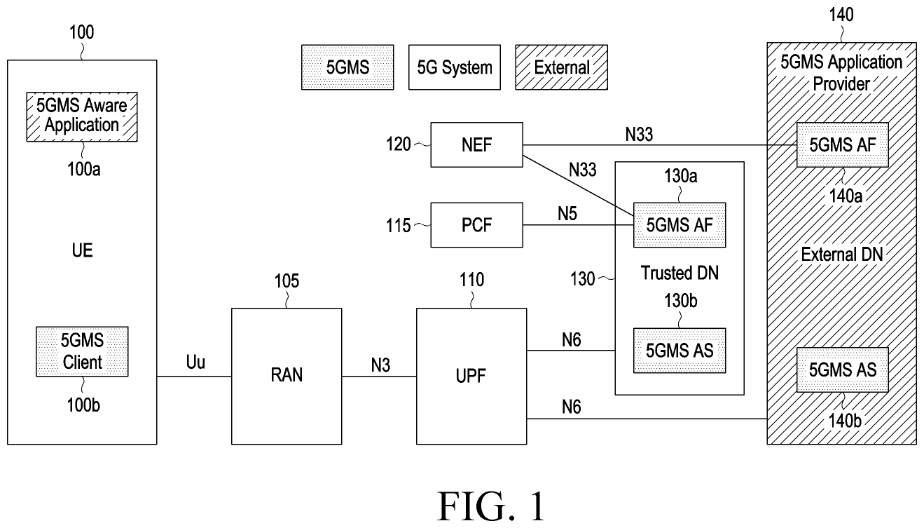

FIG. 1 illustrates an overall 5GMS architecture in a wireless communication system according to an embodiment. FIG. 1 represents the specified 5GMS functions within the 5GS as defined in the relevant Standard.

Referring to FIG. 1, the 5GMS system may be an assembly of application functions, application servers and interfaces from the 5GMS architecture that support one or both of downlink media streaming services or uplink media streaming services. The components of a 5GMS System may be provided by the MNO as part of a 5GS and/or by a 5GMS application provider 140. The 5GMS application provider 140 interacts with functions of the 5GMS System and supplies a 5GMS-aware application 100a of a UE 100 that interacts with functions of the 5GMS System.

The 5GMS-aware application 100a may be in the UE 100, provided by the 5GMS application provider 140, that contains the service logic of the 5GMS application service, and interacts with other 5GMS client 100b and network functions via the interfaces and application programming interfaces (APIs) defined in the 5GMS architecture. The 5GMS-aware application 100a associated with the delivery of a downlink related 5GMS service may be referred to as a 5GMSd-aware application. The 5GMS client 100b in the UE 100 may include a 5G media streaming client for the downlink (5GMSd) client. The 5GMSd client may be a UE function that includes at least a 5G media streaming player and a media Session handler for downlink streaming and that may be accessed through well-defined interfaces/APIs.

The 5GMS application provider 140 uses 5GMS for streaming services. The 5GMS application provider 140 provides a 5GMS aware-application 100a on the UE 100 to make use of the 5GMS client 100b and network functions using interfaces and APIs defined in 5GMS. 5GMS AF 130a, 140a may be similar to an AF defined in the relevant Standard dedicated to 5G media streaming. 5GMS AS 130b, 140b may be dedicated to 5G media streaming. The 5GMS client 100b may be a UE internal function dedicated to 5G media streaming and has a logical function and subfunctions distributed within the UE according to implementation. 5GMS AF 130a, 140a and 5GMS AS 130b, 140b are data network (DN) functions and communicate with the UE 100 via N6 as defined in the relevant Standard.

Functions in trusted DNs 130, e.g., a 5GMS AF 130a, are trusted by the operator's network Therefore, the 5GMS AF 130a may directly communicate with the relevant 5G Core functions. Functions in external DNs 140, e.g., a 5GMSvant 140a, may only communicate with 5G core functions via network exposure function (NEF) 120 using N33. The NEF 120 may be responsible for transmitting or receiving an event occurring in the 5G system and a supported capability to/from the outside.

The RAN 101 may be a base station (e.g., gNB or IAB) supporting radio access technology in the 5G system. The RAN 105 may deliver control information and/or data from the 5GMS application provider 140 to the UE 100 through a core network (i.e., 5GC). A user plane function (UPF) 110 serves to process data of the UE 100 and may play a role to transfer data transmitted from the UE 100 or process data to allow data introduced from the 5GMS AF/AS to be transferred to the UE 100. The UPF 110 may perform network functions, such as acting as an anchor between radio access technologies (RATs), providing connection with PDU sessions and the 5GMS AF/AS, packet routing and forwarding, packet inspection, application of user plane policy, creating a traffic usage report, or buffering. A policy control function (PCF) 115 is an NF that manages operator policy information for providing a service in the 5G system.

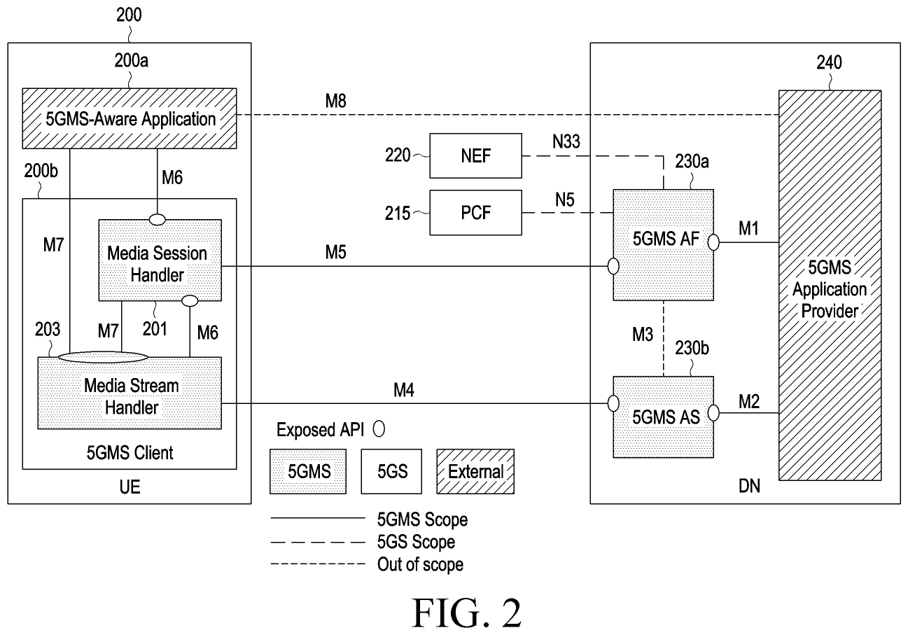

FIG. 2 illustrates a 5GMS general architecture in a wireless communication system according to an embodiment. FIG. 2 represents media streaming functional entities and interfaces are specified within the disclosure.

Referring to FIG. 2, a system may include a UE 200, a DN, NEF 220, and PCF 215, etc. The UE 200 include 5GMS-aware application 200a and 5GMS client 200b, and The DN include 5GMS AF 230a, 5GMS AS 230b and 5GMS application provider 240. Since the basic functions of NFs/network entities shown in FIG. 2 are the same as those of the corresponding NFs/network entities shown in FIG. 1, detailed descriptions thereof will be omitted. In FIGS. 2, M1, M6 and M7 are interfaces used in the 5GMS general architecture, which are found in 3GPP TS 26.501.

The 5GMS client 200b may include a media session handler 201 and a media stream handler 203. The 5GMS client 200b in the UE 200 is depicted in the form of media session handler 201 and media stream handler 203 constituent functions which expose APIs to one another in the same way that those APIs are exposed to 5GMS-aware application(s) 200a. The media session handler 201 may communicates with the 5GMS AF 230a to establish and control the delivery of a media streaming session, and which also exposes APIs to the 5GMS-aware application 200a. The media streaming session denotes a session initiated by a 5GMS-aware application 200a that involves one or more media streams being delivered between the 5GMShat 230b and the 5GMS client 200b via reference point M4.

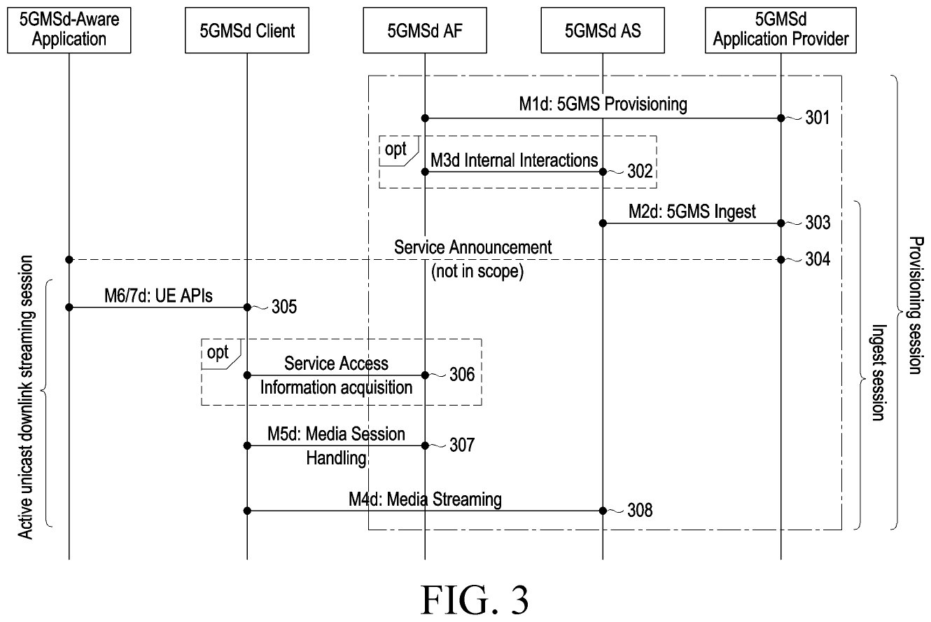

FIG. 3 illustrates a high level procedure for media downlink streaming in a wireless communication system according to an embodiment. Since the basic functions of NFs/network entities shown in FIG. 3 are the same as those of the corresponding NFs/network entities shown in the above FIGS. 1 and/or 2, detailed descriptions thereof will be omitted.

Referring to FIG. 3, an ingest session refers to a time interval during which media content is uploaded to the 5GMSd AS. A provisioning session refers to a time interval during which the 5GMSd client may access media content and the 5GMSd application provider may control and monitor the media content and its delivery. Interactions between the 5GMSd AF and the 5GMSd application provider may occur at any time while the provisioning session is active. The 5GMSd provisioning API at M1d allows selection of media session handling (M5d) and media streaming (M4d) options, including whether the media content is hosted on trusted 5GMSd AS instances.

Referring to FIG. 3, in step 301, the 5GMSd application provider creates the provisioning session with the 5GMSd AF and starts provisioning a usage of the 5G media streaming system. During the establishment phase, the used features may be negotiated and detailed configurations be exchanged. The 5GMSd AF receives service access information for M5d (media session handling) and, where media content hosting is negotiated, service access information for M2d (Ingestion) and M4d (Media Streaming) as well. This information is needed by the 5GMSd client to access the service. Depending on the provisioning, a reference to the service access information may be supplied.

In step 302, (Optional) when content hosting is offered and selected there may be interactions between the 5GMSd AF and the 5GMSd AS, e.g., to allocate 5GMSd content ingest and distribution resources. The 5GMSd AS provides resource identifiers for the allocated resources to the 5GMSd AF, which then provides the information to the 5GMSd application provider.

In step 303, the 5GMSd application provider starts the ingest session by ingesting content. In live services, the content is continuously ingested. In on-demand streaming services, the content may be uploaded once and then updated later. A 5GMSd AS in the external DN may provide the content hosting.

In step 304, the 5GMSd application provider provides the service announcement information to the 5GMSd-aware application. The service announcement information includes either whole service access information (i.e., details for media session handling (M5d) and for media streaming access (M4d)) or a reference to the service access information or pre-configured information. When only a reference is included, the 5GMSd client fetches (in in step 306) the services access information when needed.

In step 305, when the 5GMSd-aware application decides to begin streaming, the service access information (all or a reference) is provided to the 5GMSd client. The 5GMSd client activates the unicast downlink streaming session.

In step 306, (Optional), in case the 5GMSd client received only a reference to the service access information, then the 5GMSd client acquires the service access information from the 5GMSd AF. Pre-caching of service access information may also be supported by the 5GMS client to speed up the activation of the service.

In step 307, the 5GMSd client uses the media session handling API exposed by the 5GMSd AF at M5d. The media session handling API is used for configuring content consumption measurement, logging, collection and reporting; configuring quality of experience (QoE) metrics measurement, logging, collection and reporting; requesting different policy and charging treatments; or 5GMSd AF-based network assistance. The actual time of API usage depends on a feature and interactions that may be used during the media content reception.

In step 308, the 5GMSd client activates reception of the media content.

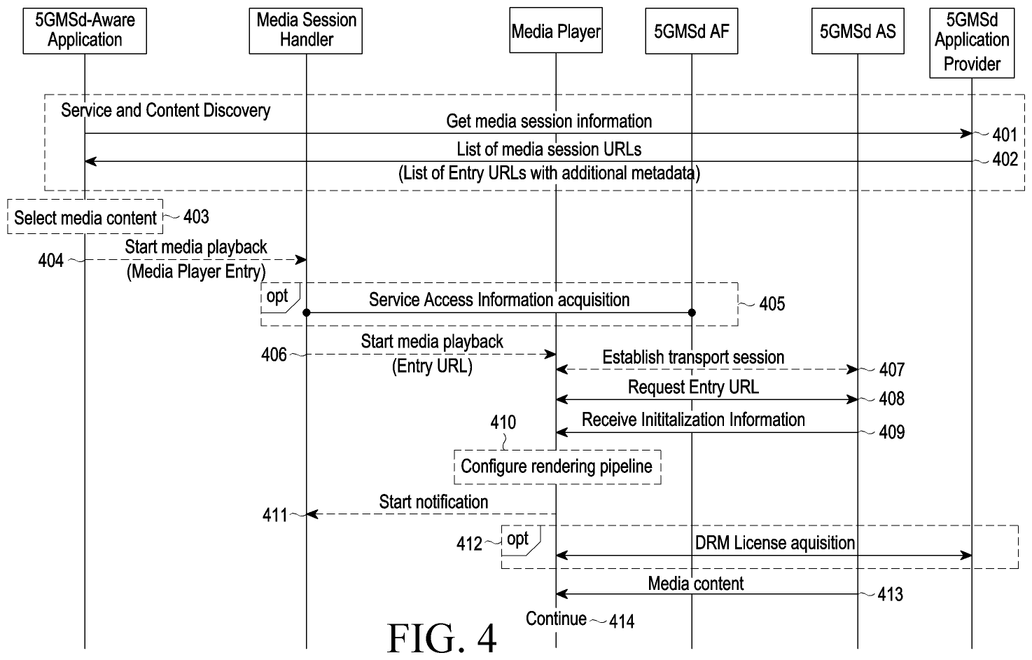

FIG. 4 illustrates a baseline procedure describing an establishment of a unicast media downlink streaming session in a wireless communication system according to an embodiment.

Since the basic functions of NFs/network entities shown in FIG. 4 are the same as those of the corresponding NFs/network entities shown in the above FIGS. 1 and/or 2, detailed descriptions thereof will be omitted. The baseline procedure assumes that the 5GMSd AF and the 5GMSd AS both reside in the external DN. Also, the baseline procedure assumes that 5GMSd application provider has provisioned the 5GMS system and has set up content ingest and 5GMSd-aware application has received the service announcement information from the 5GMSd application provider.

Referring to FIG. 4, in steps 401 and 402, the 5GMSd-aware application triggers service announcement and service and content discovery procedure. The service announcement information includes either whole service access information (i.e., details for media session handling (M5d) and for media streaming access (M4d)) or a reference to the service access information.

In step 403, a media player entry is selected.

In step 404, the 5GMSd-aware application triggers the media session handler to start the playback. The media player entry is provided to the media session handler.

In step 405, (Optional), when the 5GMS-aware application has received a reference to the service access information, the media session handler interacts with the 5GMSd AF to acquire the whole service access information.

In step 406, the media session handler triggers the media player to start the session.

In step 407, the media player establishes the transport session. The UE may include the (5GMSd) media player that enables playback and rendering of a media presentation based on a media player entry and exposing some basic controls such as play, pause, seek, stop to the 5GMSd-aware application.

In step 408, the media player sends a request for progressive download content.

In step 409, the media player receives initialization information of the progressive download content. The initialization information includes configuration parameters for reception of the media and, optionally, also digital rights management (DRM) information.

In step 410, the media player configures the rendering pipeline for media playback.

In step 411, the media player notifies the media session handler, providing the transport session information and some media content related information.

In step 412 (Optional), the media player acquires a DRM license from the 5GMSd application provider.

In step 413, the media player receives media content and puts the media content into the rendering pipeline.

In step 414, the media player continuously receives and plays back the media content.

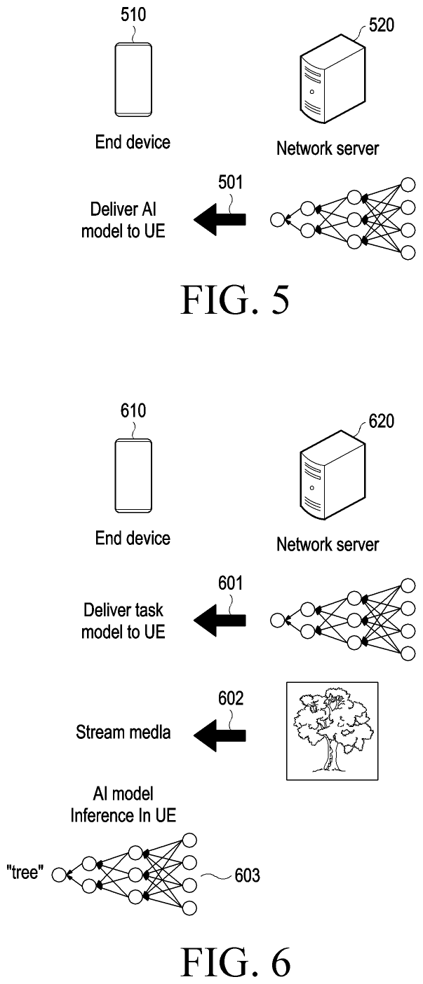

FIG. 5 illustrates an AI/ML media service scenario where an AI/ML model is required to be delivered from the network to the UE (end device) according to an embodiment.

In FIG. 5, AI/ML model is delivered (501) from a network server 520 to the UE (end device) 510. Upon receiving the AI model, the UE (end) device 510 performs the inferencing of the AI model, feeding the relevant media as an input into the AI model.

In an example in FIG. 5,

John is in Seoul for his summer vacation and wants to visit Lotte Tower in Jamsil for sightseeing. John cannot read Korean and finds it difficult to navigate his way to Lotte Tower.

John opens an augmented reality navigation service on his mobile phone (UE) 510. His network operator provides the service via the 5G system. Through the analysis of different information, a suitable AI model is delivered to the UE 510. Such information includes information available from the network, such as John's UE's location, his charging policy, network availability and conditions (bandwidth, latency) etc., his UE's processing capabilities and status, as well as the media properties which will be used as the input to the AI model.

Once the AI model is delivered (501) to John's UE 510, the AR navigation service initiates the camera on the phone to capture John's surroundings.

The captured video from the phone's camera is fed as the input into the AI model, and the AI model inferencing is initiated.

The output of the AI model may provide direction labels (such as navigation arrows which are shown as overlays in the phone's screen live camera to guide John to Lotte Tower. Road signs in Korean may be also overlayed by English labels output from the AI model.

FIG. 6 illustrates when an AI model is delivered to the UE, and video) is streamed to the UE according to an embodiment. In the UE, the streamed video is fed as an input into the received AI model for processing.

Referring to FIG. 6, an AI model is delivered (601) from a network server 620 to the UE (end device) 610, and media (such as video) is streamed (602) to the UE 610 and is fed as an input into the received AI model for processing.

The AI model may perform any media related processing, such as video upscaling, video quality enhancement, vision applications such as object recognition (e.g. “tree” recognition as in FIG. 6), and facial recognition.

A description of the required operations includes at least one of (service announcement, request/selection by the UE or network (which task UE wants to perform, takes into account media requirements, network status parameters, UE status parameters, network or UE selects suitable AI model), a provision & ingest model in the network, provision media in the network, session(s) establishment(s), a delivery AI model from the network to a UE, a configure media session downlink, stream media from the network, and AI media inference (603) in the UE.

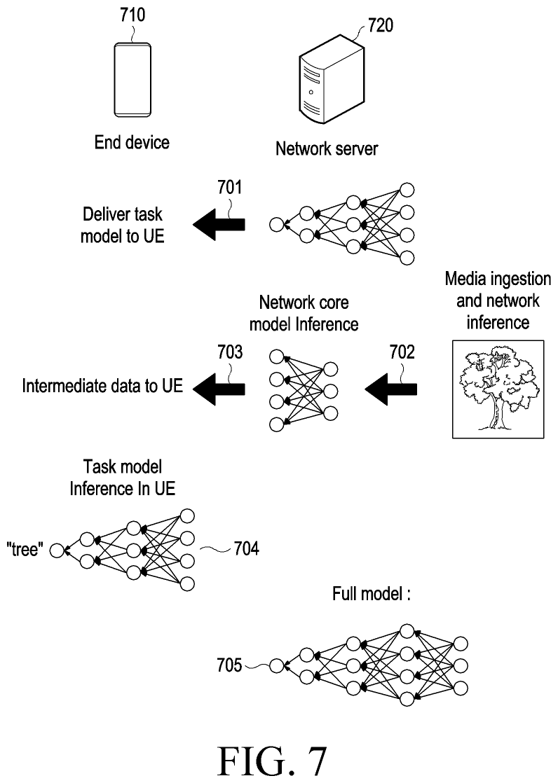

FIG. 7 illustrates when the inferencing required for the AI media service is split between the network and UE (end device) according to an embodiment.

Referring to FIG. 7, a portion of the AI model to be inferenced on the UE 710 is delivered (701) from a network server 720 to the UE (end device) 710. Another portion of the AI model to be inferenced in the network is provisioned by the network server 720 to an entity which performs the inferencing in the network. The media for inferencing is firstly provisioned and ingested (702) by the network server 720 to the network inferencing entity which feeds the media as an input into the network portion of the AI model. The output of the network side inference (intermediate data) is (703) then sent to the UE 710, which received this intermediate data and feeds it as an input into the UE side portion 704 of the AI model, hence completing the inference of the full model 705.

In FIG. 7, the split decision and configuration is negotiated between the UE and the network server 720, and a description of the required operations includes at least one of service announcement, request/selection by UE (which task the UE wants to perform, gives media requirements, AF selects suitable model head), provision UE task model head and core model in the network, provision media in the network, split configuration setup & establishment, session(s) establishment(s) where intermediate data session downlink is configured, download/stream model head from the network, perform network core model inference, stream intermediate data from the network, and task model inference in the UE.

In one split configuration example, an AI model service may consist of a core portion, as well as a task specific portion (e.g. traffic sign recognition task, or facial recognition task), where the core portion of the AI model is common to multiple possible tasks. In this case, the split configuration may coincide the core and task portions in a manner such that the network performs the inference of the core portion of the model, and the UE (receives and) performs the inference of the task portion of the model.

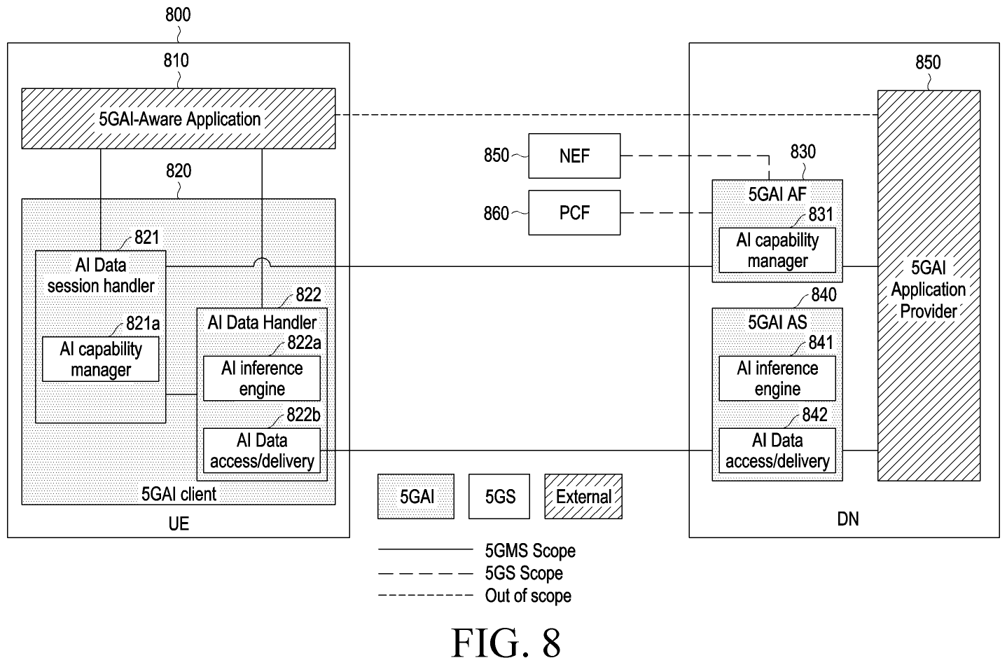

FIG. 8 illustrates AI for media (AI4Media) architecture which identifies the various functional entities and interfaces for enabling AI model delivery for media services according to an embodiment. The basic functions of NFs/network entities shown in FIG. 8 may have similar functionality to those corresponding to described in FIGS. 1 and/or 2.

Referring to FIG. 8, UE 1000 may include 5GAI-aware application 810 and 5GAI client 820. The 5GAI client 820 may include an AI data session handler 821 and an AI data handler 822. The AI data session handler 821 may include AI capability manager 821a, and the AI data handler 822 may include an AI inference engine 822a and an AI data access/deliver function 822b. The DN may include 5GAI AF 830, 5GAI AS 840, and 5GAI application provider 850. The 5GAI AF 830 may include AI capability manager 831, and the 5GAI AS 840 may include an AI inference engine 841 and an AI data access/delivery function 842. The AI capability manager 821a, the AI inference engine 822a and the AI data access/delivery function 822b correspond to logical functions at a UE side related to AI/ML, and the AI capability manager 831, the AI inference engine 841 and the AI data access/delivery function 842 correspond to logical functions at a network side related to AI/ML. The entities/features in FIG. 8 are described in detail below.

The 5GAI AF 830 is an application function similar to that defined in the relevant Standard dedicated to AI media services. 5GAI AF 830 provides various control functions to the AI data session handler 821 on the UE 800 and/or to the 5GAI application provider 850. 5GAI AF 830 may interact with other 5GC network functions, such as a data collection proxy (DCP) function entity which interacts with the AI/ML endpoint and/or 3GPP CN to collect information required for the 5GAI AF. The DCP may or may not include a network data analytics function (NWDAF) which analyses data collected from NFs defined in the relevant Standard. The 5GAI AF 830 may contain logical subfunctions such as an AI capability manager 831, which handles the negotiation and handling of capability related data and decision in the network and between the network and UE 800.

The 5GAI AS 840 is an application server (AS) dedicated to AI media services, which hosts 5G AI media (sub) functions, such as the AI data delivery/access function 842 and AI inference engine 841. The 5GAI AS 840 typically supports AI model hosting by ingesting AI models from an AI media application provider 850, and egesting models to other network functions for network inferencing, such as the Media AS. The 5GAI AS 840 may also contain media AS functionalities and an AI inference engine subfunction 841 which performs full or partial inferencing on the network.

The 5GAI media application provider 850 is an external application, with content-specific media functionality, and/or AI-specific media functionality (AI model creation, splitting, updating etc.).

The 5GAI Client 820 in the UE 800 includes an AI data session handler 821 and an AI data handler 822. The AI Data Session Handler 821 is a function on the UE 800 that communications with the 5GAI AF 830 to establish, control and support the delivery of an AI model session, and/or a media session, and may perform additional functions such as consumption and quality of experience (QoE) metrics collection and reporting. The AI data session handler 821 may expose application programming interfaces (APIs) that can be used by the 5GAI aware application 810. The AI data session handler 821 may contain logical subfunctions such as an AI capability manager 821a, which handles the negotiation and handling of capability related data and decision internally in the UE 800, and between the UE 800 and network.

The AI Data Handler 822 is a function on the UE 800 that communicates with the AI AS 840 to download/stream (or upload) the AI model data, and may provide APIs to the 5GAI aware application 810 for AI model inferencing, and to the AI data session handler 821 for AI model session control in the UE 800, and also may include the subfunctions AI data access/delivery function 822b for accessing AI model data such as topology data and or AI model parameters (weights, biases), and AI inference engine 822a for inferencing in the UE 800.

Alternatively, the AI inference engine 822a in the UE 800 may exist outside the AI data handler 822. AI inference engine 822a may also exist in another function in the UE 800.

Alternatively, the AI inference engine 841 in the network may exist outside the 5GAI AS 840.

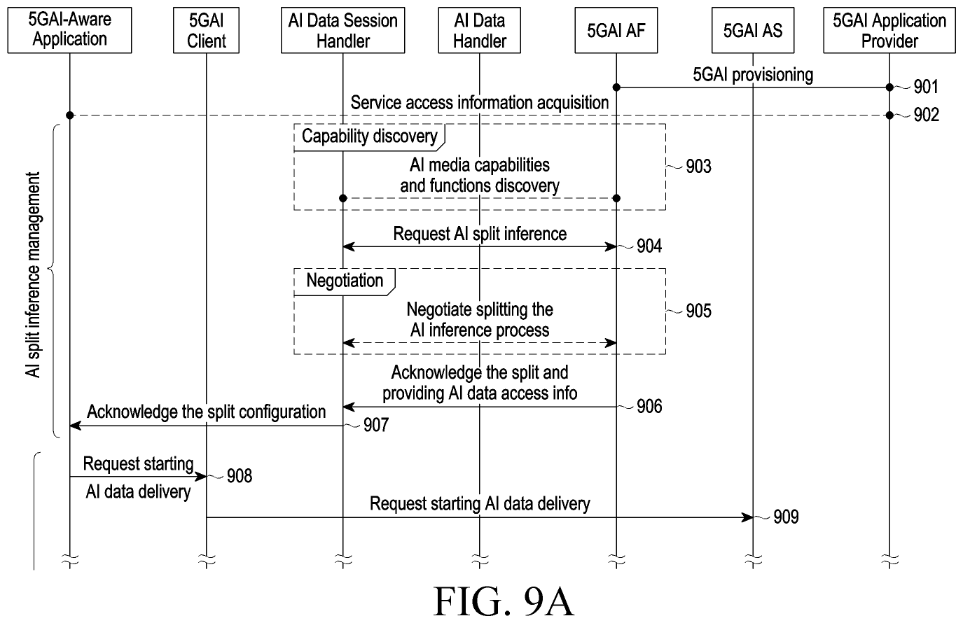

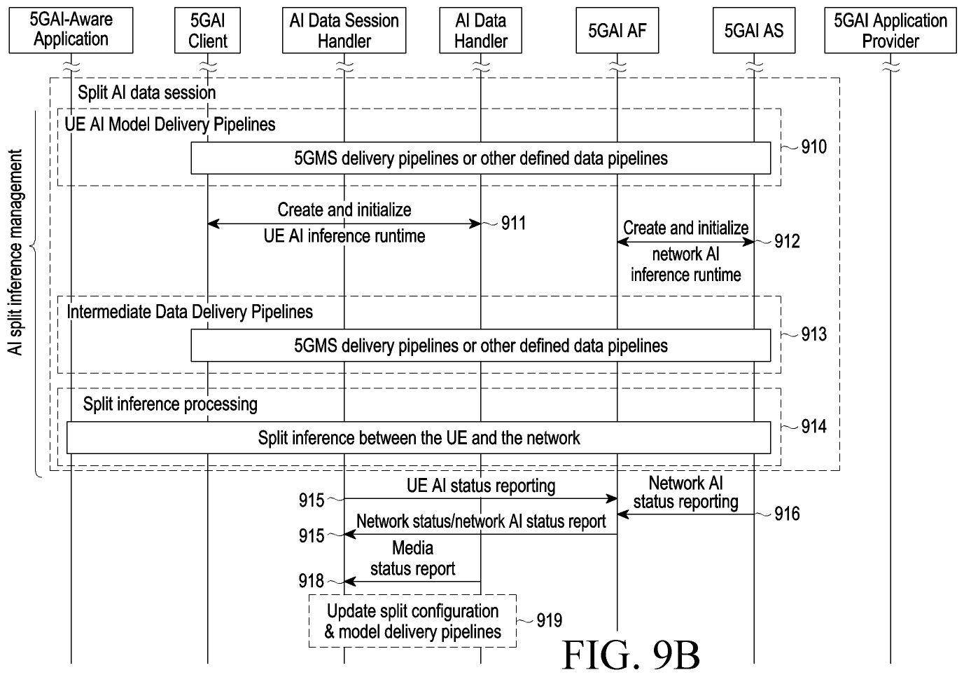

FIGS. 9A and 9B illustrate a procedure for the delivery of an AI model with configurations between the network and UE according to an embodiment.

Referring to FIGS. 9A and 9B, functions of NFs/network entities are the same as those of the corresponding NFs/network entities shown in the above FIG. 8, detailed descriptions thereof will be omitted. At least one of 5GAI-aware application, 5GAI client, AI data session handler, and AI data handler shown in FIG. 9 may be included in the UE. At least one of 5GAI AF, 5GMS AS, and 5GAI application provider may be included in one or more network servers at a network side. In step 901, service provisioning and announcement of AI media service may be performed between the 5GAI application function (AF) and the 5GAI application provider.

In step 902, 5GAI-aware application of the UE may receive/obtain Service access information including a required AI model for the service is known in service access information (AI model known). In step 902, the available or required AI model(s) for the service can be made known to the UE, by information made available via a uniform resource locator (URL) link pointing to a file or manifest which may last such available AI models.

The received information may already contain AI model specific information, such as the size of the AI model network, including the number of layers contained in the AI model structure, the number of nodes and links in each layer, the complexity of each layer in the AI model (i.e. the number of free parameters), the possible split points for the model for split inferencing, and the AI model target inference delay.

Although not shown in FIG. 9, additional steps may be performed for model request/subscribe, building/ingesting adapted model if not available, and model selection.

In step 903, cloud/edge and client AI media inferencing capabilities and functions are discovered between the AI data session handler and 5GAI AF. Step 903 may also be performed between the AI data session handler and the 5GAI AS. The details in step 903 will be explained later.

In step 904, an AI split inference is requested between the AI data session handler and the 5GAI AF. Either the UE or the network server may request the other side for the above-described AI split inference.

In step 905, negotiation for splitting the AI media inference process may be performed between AI data session handler and 5GAI AF based on at least one of the following.

A split point for splitting the AI media inference process may be determined in step 905, and the requirements for such a split point decision may be that such as the total AI model target inference delay (or latency) for the service. To determine the split point, data received from steps 902 to 905 may be used for various calculations on deciding a split point, in one or both of the UE or in the network.

Once a split point is decided, the configuration for the delivery of the split AI model may occur in step 905. Alternatively, the configuration for the delivery of the split AI model may occur when configuring the delivery pipelines for the below in step 910. Such configurations may include at least one of
Configuration: static_split or dynamic_split;

Whether the split configuration is static during the service or may be changed dynamically depends on factors in/during the service.

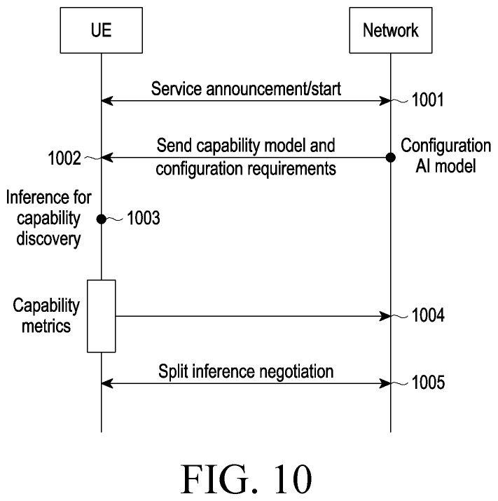

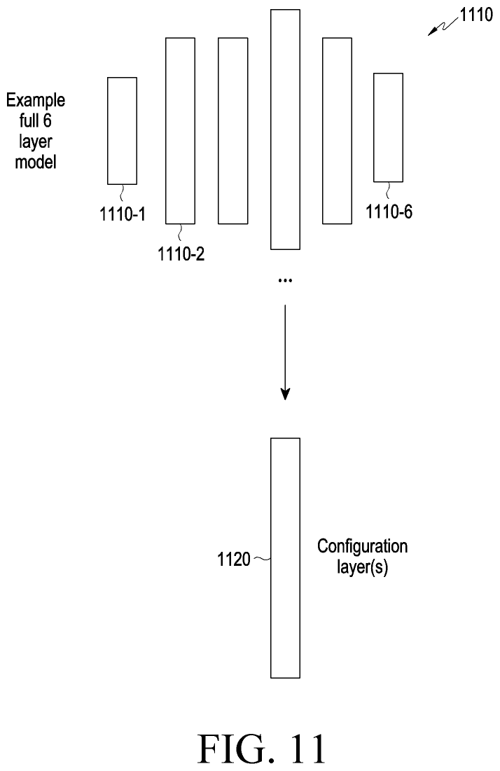

If dynamic_split, subset_models_flag (indicates availability of subsets);
If the split configuration is assigned to be dynamic, the structure of the split AI models may be as shown in FIGS. 9A and 9B, or FIG. 10 or FIG. 11. When the split AI model is divided into independent subsets as in FIGS. 10 and 11, an indication that a subset structure is used may be given, using parameters such as a flag, or similar.

For dynamic split configuration, the AF sends AI model split point metadata to the data session handler.
Additional metadata related to the split configurations and split points may be sent to the data session handler (in addition to those in step 902 or 903). Such metadata may include at least one of subset related metadata and split point related metadata. The subset related metadata indicates the number of subsets, subset index for each subset, input and output layer number/index for each subset, the number of, and types of operators in each subset, input/output tensor indexes of each independent subset.

The split point related metadata (based on subsets) indicates the subset indexes related to each split point (e.g. network split endpoint last output subset and UE split endpoint first input subset).

In step 906, acknowledgement of the AI split inferencing and providing the AI data split inferencing access information may be performed between the AI data session handler of the UE and the 5GAI AF of the network.

In step 907, acknowledgement of the AI split inferencing may be performed between the AI data session handler and the 5GAI-aware application of the UE.

In step 908, the 5GAI-aware application requests the start of AI data/media delivery to 5GAI client.

In step 909, the UE (5GAI client) requests, to the 5GAI AS, the start of the AI data delivery from the network.

In FIG. 9B, for UE AI model delivery pipelines, 5GMS delivery pipelines or other defined data pipelines may be configured between the 5GAI client and 5GAI AS in step 910. Creating and initializing UE AI inference runtime may be performed in 5GAI client including AI data handler in step 911. Creating and initializing network AI inference runtime may be performed between 5GAI AI and 5GAI AS in step 912. For intermediate data delivery pipelines, 5GMS delivery pipelines or other defined data pipelines may be configured between the 5GAI client and 5GAI AS in step 913. Split inferencing between the UE and the Network may be performed in step 914. In steps 910 to 914, the configuration of the AI model and data delivery pipelines may include the same parameters, procedures and/or configurations as described in step 905.

In step 915, the UE (AI data session handler) may report its AI status to the network (5GAI AS).

In step 916, the AI status (in particular split inference related status) on the network side may be also reported to the 5GAI AF from 5GAI AS.

In step 917, the network related AI status report may be sent to the UE (AI data session handler) from 5GAI AF.

In step 918, the media status is also aggregated by the AI data session handler.

In step 919, an update of the split configuration (e.g. changing the split point for split inferencing) may occur between the AI data session handler and the AI data handler. The control signaling of this split point re-configuration (or dynamic configuration) may utilize the metadata as described in step 905.

FIG. 10 illustrates a procedure corresponding to step 903 in FIG. 9A. The procedure of FIG. 10 may be performed between the AI data session handler of the UE and the 5GAI AF of the network or between the AI data session handler of the UE and the 5GAI AS of the network.

In step 1001, service announcement of AI media service may be performed between the UE and the network.

In step 1002, for the discovery of UE device AI capabilities and functions, a trained configuration AI model (that is, a capability model for checking a capability of the UE) may be sent by the network to the UE, together with sample configuration input data, and also metadata corresponding to capability discovery configuration requirements.

In step 1003, on receipt, the UE uses this data received in the In step 1002 to perform a basic inference of the trained configuration AI model, using the configuration input data, and computing the relevant capability metrics as indicated in the configuration requirements.

In step 1004, the capability metrics are then sent to the network by the UE.

In step 1005, split inference negotiation may be performed, using these capability metrics between the UE and the network as part of the negotiation decision as in step 905 in FIG. 9A.

FIG. 11 illustrates a trained configuration AI model for the capability configuration procedure described in the embodiment shown in FIG. 10.

In FIG. 11, for a given AI media service where a required AI model (1110) consists of 6 layers (1110-1, 1110-2, . . . , 1110-6) as shown, an example configuration AI model (1120) may consist of one or more layers trained AI model which are consistent with the characteristics of the 6 layer AI model. The configuration AI model (1120) may be used as the capability model for the split inference negotiation.

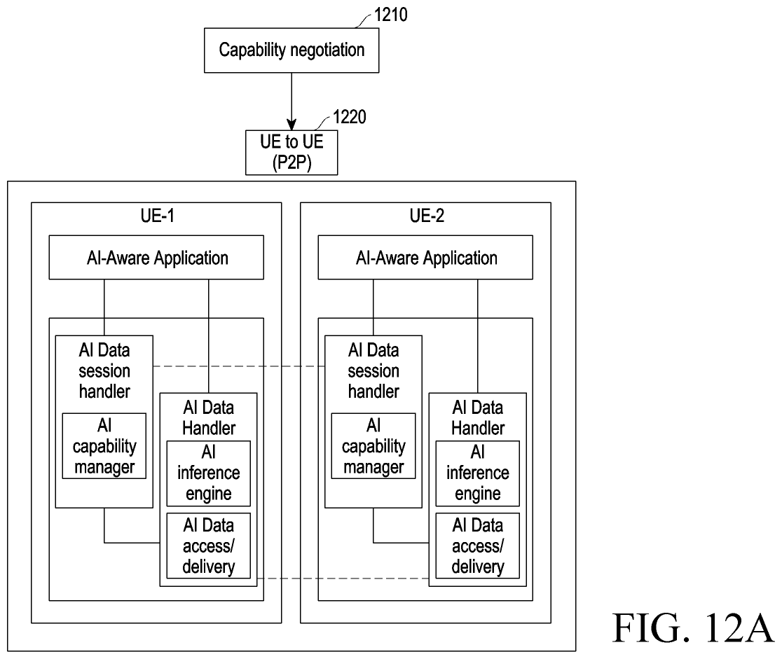

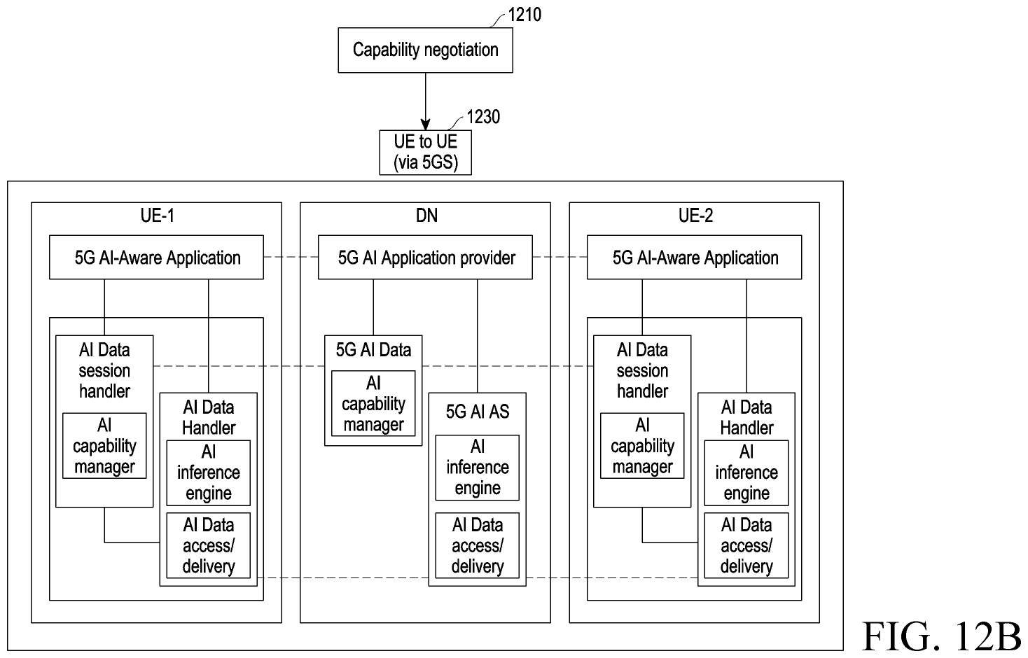

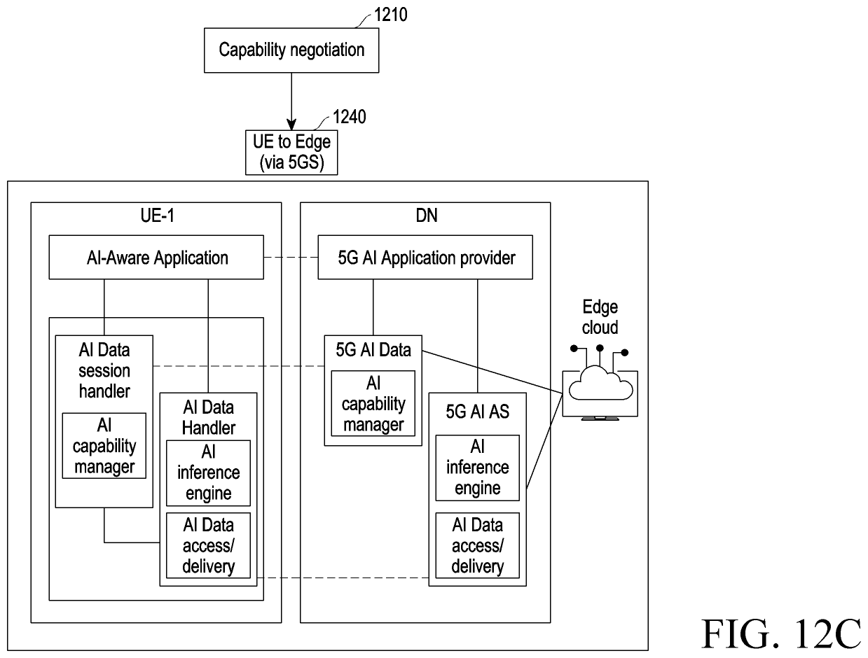

FIGS. 12A, 12B and 12C illustrate different scenarios for which embodiments of capability negotiation are applicable.

Functions of NFs/network entities shown in FIGS. 12A, 12B and 12C are the same as those of the corresponding NFs/network entities shown in the above FIG. 8, detailed descriptions thereof will be omitted. At least one of 5GAI-aware application, 5GAI client, AI data session handler, and AI data handler shown in FIGS. 12A, 12B and 12C may be included in the UE. At least one of 5GAI AF, 5GMS AS, and 5GAI application provider may be included in one or more network servers at a network side.

In addition to the scenario represented in FIGS. 8 and 10, where capability negotiation (1210) may occur between a UE and media network applications in a trusted data network where network processing and split inferencing occur, 3 additional scenarios are shown in FIGS. 12A, 12B and 12C.

In UE to UE (P2P) (1220), split inferencing occurs between two UE devices (e.g. UE1 and UE2) connected directly through a P2P connection.

Communication uses wireless fidelity (WiFi)/WiFi-direct based methods for the transmission of AI-model, intermediate data, as well as inference results.

In UE to UE (via 5GS) (1230), communication uses 5G based DN transmission for the AI model, intermediate data and inference results. The DN acts as a relay server in this scenario.

In UE to Edge (via 5GS) (1240), the DN acts a relay server between the UE device and an edge cloud which provides processing resources for cloud inferencing.

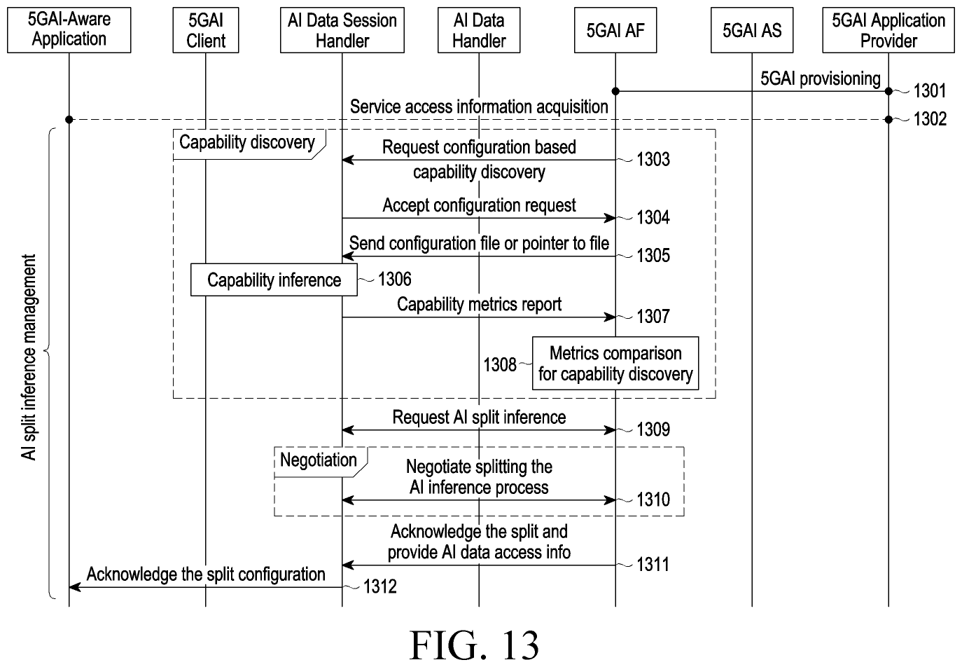

FIG. 13 illustrates the details corresponding to the procedure in FIG. 10. Detailed capability discovery is described in steps 1303 to 1307, after which the corresponding capability metric information may be used for negotiating the split configuration in the manner shown below.

The procedure of FIG. 13 may be performed between the AI data session handler of the UE and the 5GAI AF of the network, or may be performed between the AI data session handler of the UE and the 5GAI AS of the network.

In step 1301, service provisioning and announcement of AI media service may be performed between the 5GAI AF (application function) and the 5GAI application provider.

In step 1302, 5GAI-aware application of the UE may receive/obtain Service access information including required AI model(s) for the service as known in service access information (AI model known).

Although not shown in FIG. 13, additional steps may be performed for model request/subscribe, building/ingesting adapted model if not available, and model selection.

In step 1303, the network 5GAI AF may request for configuration based capability discovery to the UE (AI data session handler).

In step 1304, a configuration-based capability discovery request is accepted by the UE and is notified to the 5GAI AF by the UE (AI data session handler).

In step 1305, information necessary for configuration-based capability discovery is provided by the 5GAI AF to the UE (AI data session handler).

Prior to step 1305, the 5GAI AF may analyze the AI model architecture and overall layers and generate a minimal layered AI model containing a minimal subset of layers from the original model which best represents the complexity of the model. Examples can include long-short term memory (LSTM), gated recurrent unit (GRU) and other blocks/operations combined together with other needed intermediate operations to form a smaller deep neural network (DNN).

Once the configuration minimal layered AI model is generated or made available, the 5GAI AF may provide information to the UE on how to obtain such necessary configuration data, such as by sending of a configuration file which contains embedded configuration AI model (e.g. serialized AI model file) and configuration information, and/or a URL pointer to configuration file containing configuration AI model and configuration information.

In step 1306, the UE receives the data necessary (AI model, sample input(s), configuration information), and performs capability inferencing using the data.

The same configuration AI model may be executed in the 5GAI AS in parallel, and corresponding metrics are computed and noted. Alternatively, such capability configuration on the network side may be pre-calculated, with metric information available in the 5GAI AF.

In step 1307, the required metrics from the capability inference, as specified in the configuration information is sent by the UE to the network.

In step 1308, a comparison of the metrics generated by 5GAI AS is made with the information received from UE. This comparison gives an understanding of the comparative system performance (processing capability in terms of ratio) as well as network bandwidth, which is used when negotiating a suitable/optimized split point for the split inference AI media service.

In step 1309, AI split inference is requested between the UE (AI data session handler) and the network (5GAI AF) and is initiated by either the UE or the network.

In step 1310, splitting the AI media inference process may be negotiated between the UE (AI data session handler) and the network (5GAI AF).

In step 1311, the AI split inferencing is acknowledged and the AI data split inferencing access information is provided between the AI data session handler of the UE and the 5GAI AF of the network.

In step 1312, the AI split inferencing is acknowledged between the AI data session handler and the 5GAI-aware application of the UE.

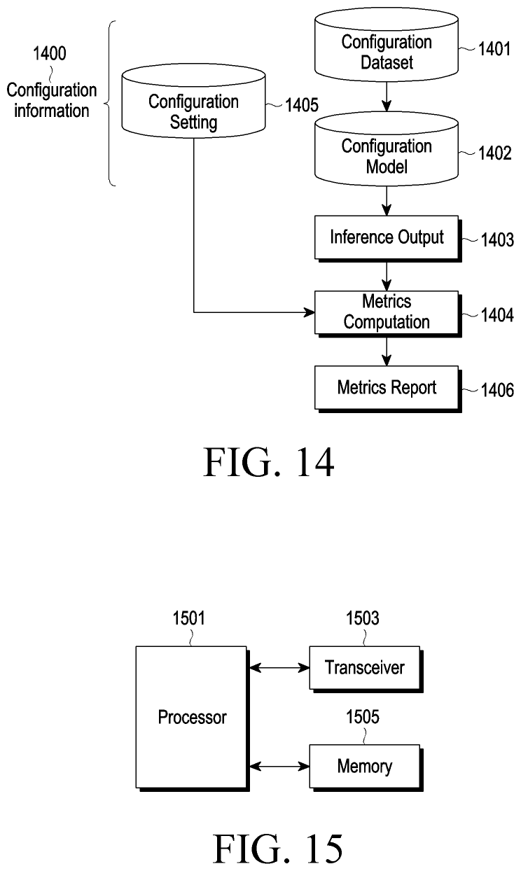

FIG. 14 illustrates a UE configuration block diagram for the process of capability configuration, using the configuration information according to an embodiment.

Referring to FIG. 14, configuration information may include at least one of a configuration dataset (1401), a configuration model (1402) and configuration setting (1405). The configuration dataset (1401) is input data which is pre-formatted for the input of the configuration model and typically includes 1 or more video frames (pictures) either in raw format, or encoded. The configuration model (1402) is a serialized AI model file including the data representing the configuration model as described in FIG. 11. Such a trained configuration AI model includes one or more layers as described in FIG. 11.

The configuration setting (1405) information includes metadata describing the configuration device procedure, such as at least one of a description of the configuration model and input configuration data, the AI framework used for the configuration, the metrics requested to be computed and reported (1404, 1406), dn service requirement constraints, such as service inference latency requirements.

Such configuration information may be obtained by the UE either received directly from the network as a configuration file (i.e. sent by the network), or through a URL pointer to the configuration file (in a format such as xml or JSON), which is provided by the network to the UE.

For the metrics to be computed, such metrics may include the inference latency (in milliseconds), metrics related to the performance of the configuration AI model and may also include hardware related metric information.

A metrics format for the metrics report may include at least one of an AI model reference/request identity (ID), inference latency (in milliseconds (ms)), a size of the output result (in bytes), and a unix time when the result was sent.

FIG. 15 illustrates a configuration of a network entity in a wireless communication system according to an embodiment.

Referring to FIG. 15, the network entity may be one of the UE, the NFs, or the network server described above.

The network entity may include a processor 1501 controlling the overall operation of the network entity according to one or a combination of two or more of embodiments of FIG. 1 to FIG. 14, a transceiver 1503 including a transmitter and a receiver, and a memory 1505. The network entity may include more or fewer components than those shown in FIG. 15.

In FIG. 15, the transceiver 1503 may transmit/receive signals to/from at least one of other network entities or the UE. In addition, the transceiver 1203 may include a communication interface for wiredly/wirelessly transmitting/receiving signals to/from another network entity. The signals transmitted/received with at least one of the other network entities or the UE may include at least one of control information and/or data.

In FIG. 15, the processor 1501 may control the overall operation of the network entity to perform operations according to one or a combination of two or more of the above-described embodiments. The processor 1501, the transceiver 1503, and the memory 1505 are not necessarily implemented in separate modules but rather as a single chip. The processor 1501 and the transceiver 1503 may be electrically connected with each other. The processor 1501 or application processor (AP), a communication processor (CP), a circuit, an application-specific circuit, or at least one processor.

The memory 1505 may store a default program for operating the network entity, application programs, and data, such as configuration information. The memory 1505 provides the stored data according to a request of the processor 1501. The memory 1505 may include a storage medium, such as read only memory (ROM), random access memory (RAM), hard disk, compact disc (CD)-ROM, and digital versatile disc (DVD), or a combination of storage media. There may be provided a plurality of memories. The processor 1501 may perform at least one of the above-described embodiments based on a program for performing operations according to at least one of the above-described embodiments stored in the memory 1505.

The programs may be stored in attachable storage devices that may be accessed via a communication network, such as the Internet, Intranet, local area network (LAN), wide area network (WLAN), or storage area network (SAN) or a communication network configured of a combination thereof. The storage device may connect to the device that performs embodiments of the disclosure via an external port. A separate storage device over the communication network may be connected to the device that performs embodiments of the disclosure.

The above-described example views of control/data signal transmission methods, example views of operational procedures, and configuration views are not intended as limiting the scope of the disclosure. The embodiments may be practiced in combination, as necessary. For example, some of the methods provided herein may be combined to operate the network entity and the UE.

The blocks in each flowchart and combinations of the flowcharts herein may be performed by computer program instructions. Since the computer program instructions may be equipped in a processor of a general-use computer, a special-use computer or other programmable data processing devices, the instructions executed through a processor of a computer or other programmable data processing devices enable performing of the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction that enables performing of the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Each block may represent a module, segment, or part of a code including one or more executable instructions for executing a specified logical function(s). Further, it should also be noted that in some replacement execution examples, the functions mentioned in the blocks may occur in different orders. For example, two blocks that are consecutively shown may be performed substantially simultaneously or in a reverse order depending on corresponding functions.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a user equipment (UE) for an artificial intelligence/machine learning (AI/ML) media service in a wireless communication system, the method comprising:
receiving, from a network server, configuration information including information on a trained configuration AI model for checking a capability of the UE associated with a AI split inferencing between the UE and the network server;
performing inferencing for a capability discovery of the UE based on the configuration information; and
transmitting, from the network server, a capability metrics of the UE based on the inferencing result.

2. The method of claim 1, further comprising:
negotiating with the network server for the AI split inferencing, based on the capability metrics.

3. The method of claim 1,
wherein an AI model required for the AI/ML media service includes a plurality of layers, and
wherein the trained configuration AI model includes at least one layer which is consistent with characteristics of the AI model required for the AI/ML media service among the plurality of layers.

4. The method of claim 1,
wherein the configuration information further includes at least one of sample configuration input data and metadata corresponding to capability discovery configuration requirements.

5. The method of claim 1,
wherein the method is performed between the UE including an AI data session handler and the network server including at least one of a 5GAI application function (AF) or a 5GAI application server (AS).

6. A user equipment (UE) for an artificial intelligence/machine learning (AI/ML) media service in a wireless communication system, the UE comprising:
a transceiver; and
a processor configured to:
receive, through the transceiver from a network server, configuration information including information on a trained configuration AI model for checking a capability of the UE associated with a AI split inferencing between the UE and the network server,
perform inferencing for a capability discovery of the UE based on the configuration information, and
transmit, to the network server through the transceiver, a capability metrics of the UE based on the inferencing result.

7. The UE of claim 6,
wherein the processor is further configured to negotiate with the network server for the AI split inferencing, based on the capability metrics.

8. The UE of claim 6,
wherein an AI model required for the AI/ML media service includes a plurality of layers, and
wherein the trained configuration AI model includes at least one layer which is consistent with characteristics of the AI model required for the AI/ML media service among the plurality of layers.

9. The UE of claim 6,
wherein the configuration information further includes at least one of sample configuration input data and metadata corresponding to capability discovery configuration requirements.

10. The UE of claim 6,
wherein the UE including an AI data session handler and the network server including at least one of a 5GAI application function (AF) or a 5GAI application server (AS).

11. A method performed by a network server for an artificial intelligence/machine learning (AI/ML) media service in a wireless communication system, the method comprising:
transmitting, to a user equipment (UE), configuration information including information on a trained configuration AI model for checking a capability of the UE associated with a AI split inferencing between the UE and the network server;
receiving, from the UE, a capability metrics of the UE based on the configuration information; and
performing a matrix comparison for a capability discovery of the UE based on the capability metric of the UE.

12. The method of claim 11, further comprising:
negotiating with the UE for the AI split inferencing, based on the matrix comparison.

13. The method of claim 11,
wherein an AI model required for the AI/ML media service includes a plurality of layers, and
wherein the trained configuration AI model includes at least one layer which is consistent with characteristics of the AI model required for the AI/ML media service among the plurality of layers.

14. The method of claim 11,
wherein the configuration information further includes at least one of sample configuration input data and metadata corresponding to capability discovery configuration requirements.

15. The method of claim 11,
wherein the method is performed between the network server including at least one of a 5GAI application function (AF) or a 5GAI application server (AS) and the UE including an AI data session handler.

16. A network server for an artificial intelligence/machine learning (AI/ML) media service in a wireless communication system, the network server comprising:
a transceiver; and
a processor configured to:
transmit, to a user equipment (UE) through the transceiver, configuration information including information on a trained configuration AI model for checking a capability of the UE associated with a AI split inferencing between the UE and the network server,
receive, through the transceiver from the UE, a capability metrics of the UE based on the configuration information, and
perform a matrix comparison for a capability discovery of the UE based on the capability metric of the UE.

17. The network server of claim 16,
wherein the processor is further configured to negotiate with the UE for the AI split inferencing, based on the matrix comparison.

18. The network server of claim 16,
wherein an AI model required for the AI/ML media service includes a plurality of layers, and
wherein the trained configuration AI model includes at least one layer which is consistent with characteristics of the AI model required for the AI/ML media service among the plurality of layers.

19. The network server of claim 16,
wherein the configuration information further includes at least one of sample configuration input data and metadata corresponding to capability discovery configuration requirements.

20. The network server of claim 16,
wherein the network server includes at least one of a 5GAI application function (AF) or a 5GAI application server (AS) and the UE includes an AI data session handler.
